(19) United States
(12) Patent Application Publication
(10) Pub. No.: US 2006/0280269 A1
(43) Pub. Date: Dec. 14, 2006

(54) Method for designing video and image scaler based on 2-D finite impulse response filter

(75) Inventor: Wen-Yi Huang, Pingtung (TW)

Correspondence Address: BACON & THOMAS, PLLC, 625 SLATERS LANE, FOURTH FLOOR, ALEXANDRIA, VA, 22314, US

(73) Assignee: Terawins, Inc., Zhong-He City (TW)

(21) Appl. No.: 11/147,275

(22) Filed: Jun. 8, 2005

(51) Int. Cl. H04B 1/10

(52) U.S. Cl. 375/350

(57) ABSTRACT

The present invention is to provide a method for designing a video and image scaler based on 2-D Finite Impulse Response (FIR) filter. First, a 2-D video/image source is sampled with sampling rate higher than Nyquist rate to obtain 2-D samples; second, zeros are padded in between the 2-D samples to get a zero padding image; third, the zero padding image is passed through a 2-D FIR filter and a scaled-up image is obtained.

### FIELD OF THE INVENTION

The present invention relates to an improvement of video and image scaler, and more particularly to a method for designing video and image scaler based on 2-D (two dimensional) Finite Impulse Response filter.

### BACKGROUND OF THE INVENTION

As we are staying in a digitalized world, digital video and image processing are widely used in many kinds of areas, such as PC, digital camera, digital TV . . . etc. Digital display such as LCD, PDP also plays a role in human daily life. There are different sizes of digital display panel in the market, while the video/image source sizes are fixed. A scaler is necessary to resize the original video/image to meet the size of different display panels.

Nowadays the scaler or interpolation implementation methods, such as bi-linear and bi-cubic are used mostly in related products. However, some drawbacks happened in between.

Previous Technology Overview

(1) Replica Method

Referring to FIG. 1, the signal size needs to be scaled to 3 times the original one. This method is just to replicate the previous points (such as A/B) and inserted as the interpolated points. The result is shown in FIG. 2, in which the points C, D are replicas of the point A.

(2) Bi-Linear Method

In this method, C and D are not the replicas of A, but a combinational of A and B. Since C is closer to A, C has more component of A. On the other hand, D has more component of B. By taking linear combination, we obtain
C=⅔*A+⅓*B
D=⅓*A+⅔*B

The result is shown in FIG. 3.

(3) Bi-Cubic Method

This method is familiar as bi-linear method except the combination equation is cubic.

Video/Image Scaling

For scaling a video/image, the methods mentioned above are applied to horizontal samples first, and then the vertical samples of the result are applied to get the final scaled video/image, as shown in FIG. 4.

Disadvantage of the Prior Art

The scaling or interpolation methods mentioned above are widely used in different kinds of fields. For a video/image scaler, discontinuous dots appear in the edges of the picture while using the replica method. Also, the picture will blur while using the bi-linear method. When using the bi-cubic method, the picture is not sharp to human eyes. No matter which method is taken, the scaler is operated in horizontal and vertical direction separately as shown in FIG. 4. However, the basis of image in the natural world is two-dimensional. Thus the result of the image processed by 1-D (horizontal or vertical) scaler will have some distortions and is not natural for human eyes.

The present invention has arisen to mitigate and/or obviate the afore-described disadvantages.

### SUMMARY OF THE INVENTION

The primary objective of the present invention is to provide a method for designing a video and image scaler based on 2-D Finite Impulse Response (FIR) filter. First, a 2-D video/image source is sampled with sampling rate higher than Nyquist rate to obtain 2-D samples; second, zeros are padded in between the 2-D samples to get a zero padding image; third, the zero padding image is passed through a 2-D FIR filter and a scaled-up image is obtained.

If a desired up-scale is L, and a desired size of image block for processing is M×N, then zeros are inserted in between an M×N 2-D samples so that a zero padding image of (M×L)×(N×L) is obtained, and a (M×L)×(N×L) 2-D FIR filter is needed; the (M×L)×(N×L) 2-D FIR filter has (M×L)×(N×L) coefficients, the zero padding image of (M×L)×(N×L) will be processed by corresponding coefficients of the (M×L)×(N×L) 2-D FIR filter and summed as a resultant image of a center pixel in the (M×L)×(N×L) image block; shift the image block to a next desired position, repeat the above process until all the zero padding images have been processed.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 shows schematically that the signal is to be scaled to 3 times the original size.

FIG. 2 shows schematically the replica method.

FIG. 3 shows schematically the bi-linear method.

FIG. 4 shows schematically the scaler is operated in horizontal and then in vertical linearly and separately.

FIG. 5 shows schematically the method according to the present invention.

FIG. 6 shows schematically the sampled signal with sampling rate higher than Nyquist rate.

FIG. 7 shows schematically the frequency spectrum of the sampled signal in FIG. 6.

FIG. 8 shows schematically that (N−1) zeros are padded in between the original samples in order to obtain an N times size image.

FIG. 9 shows schematically the frequency spectrum after zero padding in FIG. 8.

FIG. 10 shows schematically a new spectrum will be obtained after the extra signal band outside [−piN:pi/N] is filtered.

FIG. 11 shows schematically that if the sampled signal is sampled with sampling rate N times as of FIG. 6, the resultant spectrum is also the same as that in FIG. 10.

FIG. 12 shows schematically that in 2-D FIR filter method zeros are inserted between all original samples so as to form a required size.

FIG. 13 shows schematically how to implement the present invention.

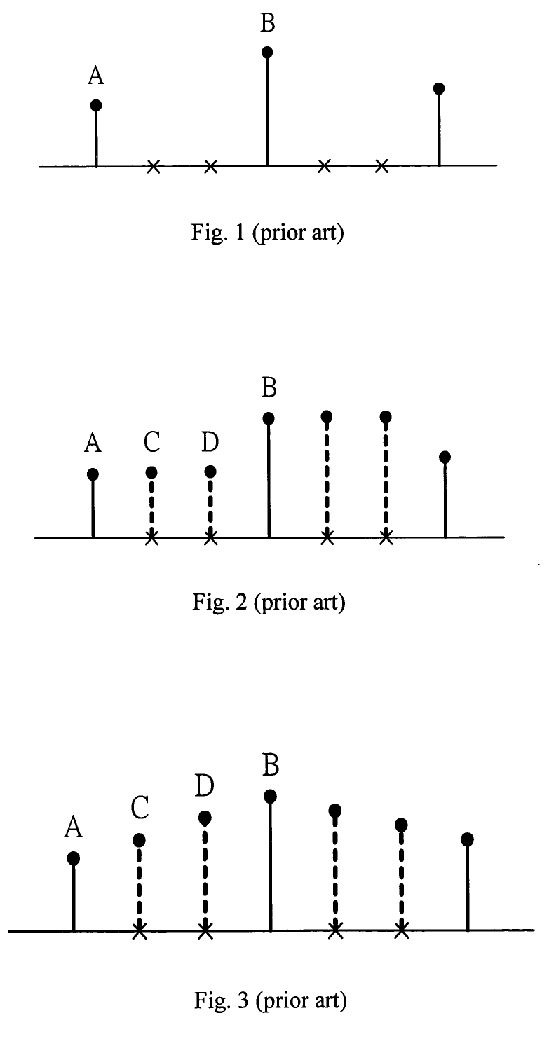

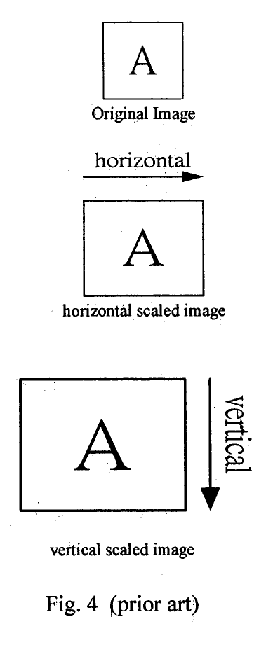

### DETAILED DESCRIPTION OF THE PREFERRED EMBODIMENT

The present invention provides a method that is based on 2-D (two dimensional) Finite Impulse Response (FIR) filter to design a scaler.

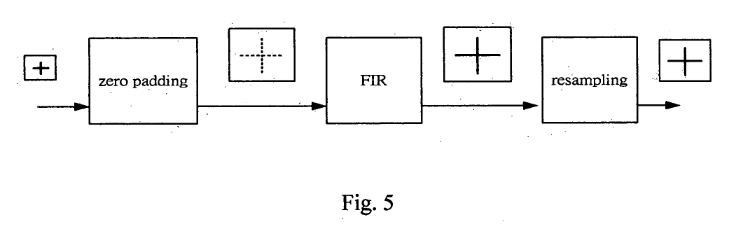

Referring to FIG. 5, in the first step, zeros are padded in btween the original samples. Next, the zero padding image is passed through a 2-D FIR filter and a scaled-up image is obtained. For the image size that is not integer times of the original size, or the size is less than the original one, it can be made by scaling-up the original size to an integer times of the result size, then take equal interval samples as the final image.

Based on the sampling theory of Digital Signal Processing, the digitalized signal can be recovered to the original analog signal only if the sampling rate is higher than Nyquist rate. It is obtained by filtering out the extra high frequency band to get a signal spectrum exactly the same as the original spectrum. The higher sampling frequency, the lower low pass filter is required.

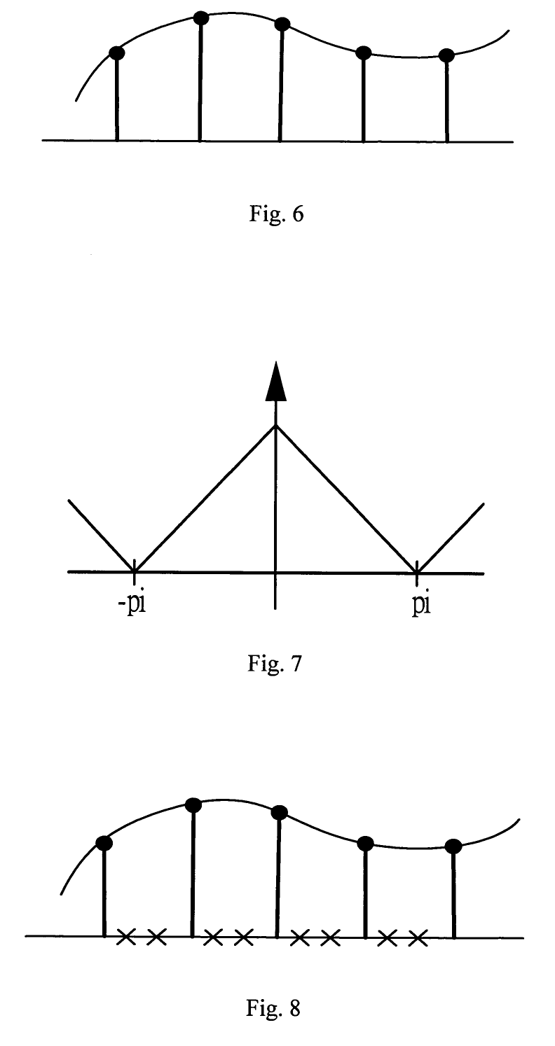

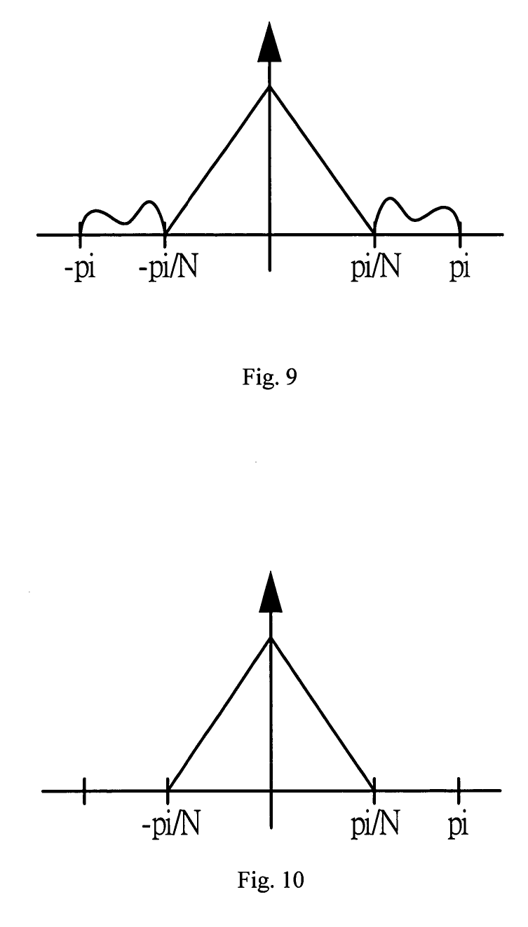

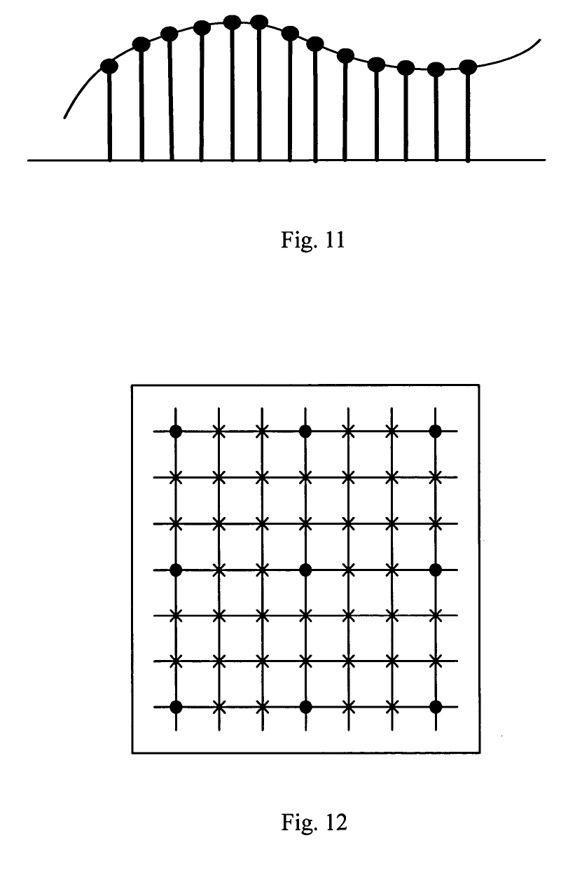

For example, FIG. 6 shows the sampled signal with sampling rate higher than Nyquist rate, and FIG. 7 is its spectrum. To obtain an N times size image, (N−1) zeros are padded in between the original samples as shown in FIG. 8. FIG. 9 is the spectrum after zero padding. If we filter the extra signal band outside [−pi/N:pi/N], a new spectrum as shown in FIG. 10 will be obtained. If the sampled signal is sampled with sampling rate N times as of FIG. 6, as shown in FIG. 11, the resultant spectrum is also the same as that in FIG. 10. This proves that zero padding has the same effect as a higher sampling rate of the original signals.

The method described above is based on 1-D FIR filter. The present invention we proposed is based on 2-D FIR filter, that means it is not necessary to scale image horizontal and vertical separately. The 2-D FIR coefficient can be separable and non-separable. Since it has to be linear phase for the filter to avoid getting blurred image, the 2-D FIR coefficients are symmetric by the center point.

The 2-D FIR filter method is the same as the 1-D FIR filter method, zeros are inserted between all original samples to a required size as shown in FIG. 12.

Filtering out band spectrum of the zero padding image by a 2-D FIR filter directly, the result image has the same spectrum as the over sampled signal. Resize the up-scaled image and take the desired samples that have equal distance as the obtained image.

Implementation

Scaler related products are applied in PC LCD monitor, LCD TV, PDA, . . . etc. For the economic efficiency, these kinds of product are implemented as micro-chips or ICs. In the following, we describe how to design a scaler. It can be easily implemented by VHDL/Verilog RTL hardware code.

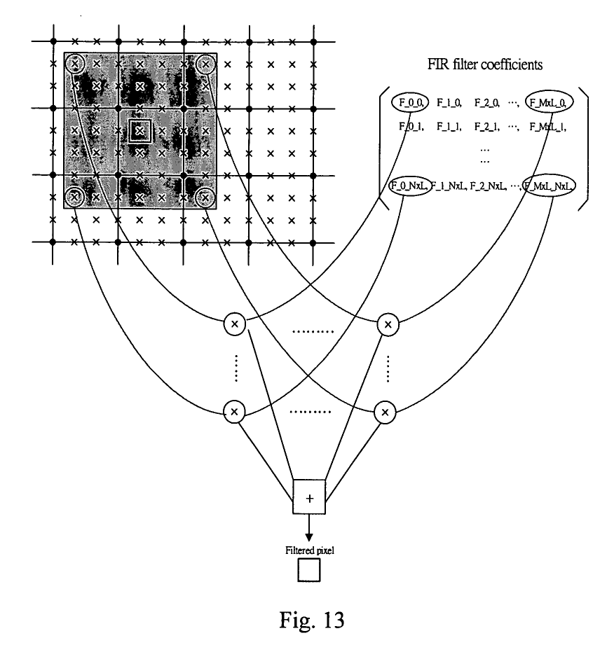

Referring to FIG. 13, the first step is to restore the original image into a memory. Choose the desired up-scale in horizontal and vertical direction, said L. Choose the image block size for the processing of FIR filtering, said M×N. Insert zeors to the M×N image (the shaded area in FIG. 13) so that we will have a zero padding (M×L)×(N×L) image. Then we need a (M×L)×(N×L) 2-D FIR filter. The coefficients of the 2-D FIR are shown at the right upper part in FIG. 13 and as below:

{F_{—}0_{—}0, F_{—}1_{—}0, F_{—}2_{—}0, . . . F_M×L_{—}0, F_{—}0_{—}1, F_{—}1_{—}1, F_{—}2_{—}1, . . . F_M×xL_{—}1, . . . F_{—}0_N×L, F_{—}1_N×L, F_{—}2_N×L, . . . F_M×L_N×L}

Filtering

To get the output of the zero padding pixels, we have to filter the image by a 2-D FIR filter. The zero padding (M×L)×(N×L) images will be processed by corresponding coefficients and summed as the resultant image of the center pixel (shown by a small square box in the center of shaded area in FIG. 13). Shift the image block to the next desired position, convolute again, we get next output pixel. Repeat this process until all the zero padding pixels have been convoluted. Then we have a (M×L)×(N×L) up-scaled image. We can store the output image into memory, and select the necessary pixels to get the output image with required horizontal and vertical sizes.

The advantage of the present invention is described as below.

At First, the present invention provides a coefficient-based method instead of fixed parametric method for the implementation of scaler and interpolator. Designer can control the image quality by adjusting the FIR coefficients to make the result image sharper or smoother. The length of FIR coefficient can also be adjusted for different design requirements. The longer the length of the FIR coefficients, the better the image obtained.

Second, the present invention provides a 2-D FIR based image processing method to overthrow the old 1-D based image processing. Since the image in the real world is two-dimensional, processing image in only 1-D direction will lose image quality.

By the two reasons described above, the present invention provides an innovative and excellent method for designing scaler, interpolator and other video/image processing applications.

While we have shown and described embodiment in accordance with the present invention, it should be clear to those skilled in the art that further embodiments may be made without departing from the scope of the present invention.

What is claimed is:

1. A method for designing a video and image scaler based on 2-D Finite Impulse Response (FIR) filter, comprising the steps of:
a. a 2-D video/image source is sampled with sampling rate higher than Nyquist rate to obtain 2-D samples;
b. zeros are padded in between the 2-D samples to get a zero padding image;
c. the zero padding image is passed through a 2-D FIR filter and a scaled-up image is obtained.

2. A method for designing a video and image scaler based on 2-D Finite Impulse Response (FIR) filter according to claim 1, wherein if a desired up-scale is L, and a desired size of image block for processing is M×N, then zeros are inserted in between an M×N 2-D samples so that a zero padding image of (M×L)×(N×L) is obtained, and a (M×L)×(N×L) 2-D FIR filter is needed;
the (M×L)×(N×L) 2-D FIR filter has (M×L)×(N×L) coefficients, the zero padding image of (M×L)×(N×L) will be processed by corresponding coefficients of the (M×L)×(N×L) 2-D FIR filter and summed as a resultant image of a center pixel in the (M×L)×(N×L) image block;
shift the image block to a next desired position, repeat the above process until all the zero padding images have been processed.
